(19) United States
(12) Patent Application Publication
(10) Pub. No.: US 2005/0189986 A1
(43) Pub. Date: Sep. 1, 2005

(54) Atonal converter and inverter

(76) Inventor: Wolf Boll, Weinstadt (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/893,537

(22) Filed: Jul. 19, 2004

(30) Foreign Application Priority Data
Jul. 19, 2003 (DE) 103 329 33.1

(51) Int. Cl. G05F 1/10

(52) U.S. Cl. 327/540

(57) ABSTRACT

A method of generating a pulse-width-modulated three-phase voltage or alternating voltage (2) from a direct voltage (1) by at least one converter or inverter. The direct voltage (1) is sampled with variable pulse width intervals (t₁, t₂, t₃). This method makes it possible to suppress interfering noise in the audible range.

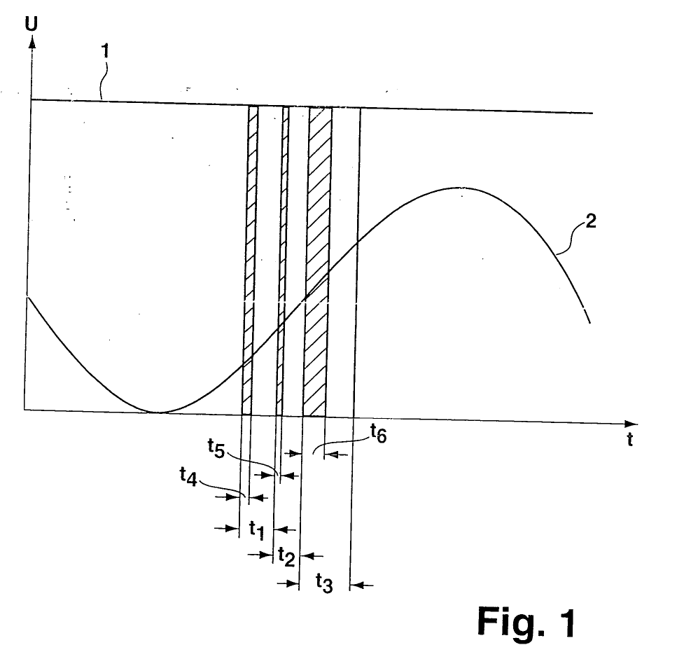

This application claims the priority of German Patent Document DE 103 329 33.1, filed 19 Jul. 2003 the disclosure of which is expressly incorporated by reference herein.

### BACKGROUND AND SUMMARY OF THE INVENTION

This invention relates to a method for creating a pulse width modulated three-phase voltage or alternating voltage from a direct voltage by means of at least one converter or inverter.

Converters and inverters for generating a three-phase current or alternating current from direct current include power semiconductors which have an increasing power loss with an increase in frequency. Such converters and inverters are used in particular to provide the power supply voltage for electric machinery for drive purposes, e.g., in fuel cell vehicles, hybrid vehicles or special rail drives. When processing a high current, the converters and inverters have an audible sound emission, which in the case of water cooling, may also cover the water pathways with structure-borne noise. The sound emission is often a high-frequency whistling which is perceived as unpleasant. This originates from the clock frequency at which a direct current is interrupted to generate a modulated, effective three-phase voltage or alternating voltage from the direct voltage by pulse width modulation.

For efficiency reasons, a high clock frequency is not desirable because high losses are generated at high frequencies in the power semiconductors. A high clock frequency of approx. 100 kHz can therefore be used only at high machine speeds. At lower speeds, the clock frequency is reduced in order to increase efficiency. However if the clock frequency is in the audible frequency range, coupling forces are generated via the currents in the electric conductors, inducing the elastic elements in the inverters and converters to produce noise.

At the same frequency, magnetostriction noises may also be caused by downstream equipment. This noise is especially unpleasant because it has a strong tonal component.

The object of the present invention is therefore to create a method with which the clock frequency can be lowered in order to increase efficiency and the tonal components of the induced vibrations can be reduced.

This object is achieved by a method of the type defined in the preamble in which the direct voltage is sampled at variable pulse width intervals. The term “pulse width interval” is understood here to refer to the period of time within which a pulse for sampling the direct voltage is generated. The pulse width intervals are selected to be different and are varied continuously, so that no specific tone is perceptible. Thus according to this invention, a specifically aperiodic clock cycle and thus an aperiodic modulation method are used. This has the result that interference noise is either not generated at all by the electric machine in which the converter or inverter is useful and/or the environment to which it is coupled, in particular the natural resonance of components, or it is stimulated with negative feedback, so that the amplitude of the interference noise is reduced and/or the character of the sound is altered. The emission of noise caused by magnetostriction can also be reduced in this way. In contrast with methods in which “white noise” is generated by a random generator, an at least partially suppressed noise is generated with a specific aperiodicity superimposed on it, so this is perceived as less annoying than a loud noise.

In one variant of this method, the relative pulse widths in the pulse width intervals generate the desired effective alternating voltage. The term “relative pulse width” is understood to refer to the ratio of the pulse duration to the length of the pulse width interval. The pulse widths of the pulses are also variable in each pulse width interval. They are preferably selected so that the desired effective alternating voltage or three-phase voltage is generated. Within a pulse width interval, the pulses may begin and end the sampling of the direct voltage at any point in time. The beginning of a pulse therefore does not necessarily coincide with the beginning of the pulse width intervals. In particular, the relative pulse widths are determined so that they correspond to the relative pulse widths in a periodic cycling, i.e., at pulse width intervals of a constant duration to generate the same predetermined alternating voltage or three-phase voltage.

It is especially preferable if the sequence of pulse width intervals is freely programmable. In particular, it may be programmed so that certain natural frequencies of the connected equipment are bypassed.

In an especially preferred variant of this method, an acoustic signal and/or a signal of one or more acceleration pickups is detected and the sequence of the pulse width interval is determined from it. The input signals are then interpreted and analyzed in such a way that no significant frequency levels above the clock frequency are induced. This interpretation of the input acoustic signals and/or the signals of one or more acceleration pickups may take place once by an input process in order to save on computation power. As an alternative, the acoustic signals and/or the signals of the acceleration pickups may be detected continuously and the pulse width interval sequence may be determined continuously. This measure makes it possible to take into account varying conditions. The pulse width interval sequence is then adapted online, i.e., in real time. Interfering noise is thus effectively suppressed in this way.

The pulse width interval sequence can be retrieved from a characteristics map as a function of the working point of an electric machine. The characteristics map contains data that is characteristic of a certain electric machine. With a knowledge of such a characteristics map, the pulse width interval sequence can be adjusted so that interfering noise from the machine, in particular natural resonance of components, is not excited at all or is excited with negative feedback. The inventive method is especially advantageous because, for each working point of the electric machine, the pulse width sequence can be adjusted on the basis of the characteristics map.

The characteristics map may be easily generated by experimentation.

The scope of the present invention also includes a device having at least one converter and/or inverter for generating a three-phase current or an alternating current from a direct current using means for pulse width modulation of a direct voltage with variable pulse width intervals. Such a device can be used preferably in drive units of electric machines, e.g., fuel cell vehicles, hybrid vehicles or rail drives. Such a device makes it possible to perform pulse width modulation at frequencies in the audible range and thereby increase the efficiency and preventing interfering noise.

It is especially preferable when a clock generator is provided which is designed so that it interprets an input acoustic signal and/or a signal of one or more acceleration pickups in such a manner that frequency levels above the clock frequency are not produced.

Other objects, advantages and novel features of the present invention will become apparent from the following detailed description of the invention when considered in conjunction with the accompanying drawings.

### BRIEF DESCRIPTION OF THE DRAWINGS

Exemplary embodiments of this invention are illustrated in greater detail on the basis of a drawing, in which:

The sole FIGURE shows a graphic plot of pulse width modulation of a direct voltage.

In the diagram of the FIGURE, the voltage U has been plotted on the ordinate and time t on the abscissa. The direct voltage 1 is sampled with pulse width modulation to generate the effective alternating voltage 2. In the pulse width intervals t₁, t₂, t₃ shown as examples, direct voltage 1 is sampled during the respective pulse duration, i.e., pulse width t₄, t₅, t₆. The pulse width intervals t₁, t₂, t₃ are selected differently so that no specific tone is discernable on the basis of their sequence and/or frequency. The sequence is aperiodic.

The relative pulse widths t₄/t₁, t₅/t₂ and t₆/t₃ are selected so that the desired effective alternating voltage 2 is obtained. Pulse widths t₄, t₅, t₆ are also variable. This yields the pulse width modulation. Because of the variable pulse width intervals t₁, t₂, t₃, tonal frequencies in the audible range are not generated by the converters and/or inverters which generate the effective alternating voltage and/or such frequencies are suppressed. This is therefore an “atonal” converter and/or inverter.

In a method for generating a pulse-width-modulated three-phase voltage or alternating voltage (2) from a direct voltage (1) by means of at least one converter or inverter, the direct voltage (1) is sampled with variable pulse width intervals (t₁, t₂, t₃). This measure makes it possible to suppress interfering noise in the audible range.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A method for generating a pulse-width-modulated three-phase voltage or alternating voltage from a direct voltage by means of at least one converter or inverter, comprising the step of:
sampling the direct voltage with variable pulse width intervals (t₁, t₂, t₃).

2. Method as claimed in claim 1, wherein the relative pulse widths (t₄/t₁, t₅/t₂, t₆/t₃) are formed by a respective ratio of pulse durations to respective duration of said pulse width intervals to generate the three-phase voltage or alternating voltage.

3. Method as claimed in claim 1, wherein a sequence of the pulse width intervals (t₁, t₂, t₃) is freely programmable.

4. Method as claimed in claim 1, further comprising the steps of detecting an acoustic signal or a signal of one or more acceleration pickups and determining a sequence of the pulse width intervals (t₁, t₂, t₃) from said step of detecting.

5. Method as claimed in claim 4, whereby the acoustic signal or the signals of the acceleration pickups are detected continuously and the pulse width interval sequence is determined continuously.

6. Method as claimed in claim 1, further comprising retrieving a pulse width interval sequence from a characteristics map as a function of a working point of an electric machine.

7. Method as claimed in claim 6, wherein the characteristics map is determined experimentally.

8. Method as claimed in claim 2, wherein a sequence of the pulse width intervals (t₁, t₂, t₃) is freely programmable.

9. Method as claimed in claim 2, further comprising the step of detecting an acoustic signal or a signal of one or more acceleration pickups and determining a sequence of the pulse width intervals (t₁, t₂, t₃) from said step of detecting.

10. Method as claimed in claim 3, further comprising the steps of detecting an acoustic signal or a signal of one or more acceleration pickups and determining a sequence of the pulse width intervals (t₁, t₂, t₃) from said step of detecting.

11. Method as claimed in claim 2, further comprising retrieving a pulse width interval sequence from a characteristics map as a function of a working point of an electric machine.

12. Method as claimed in claim 3, further comprising retrieving a pulse width interval sequence from a characteristics map as a function of a working point of an electric machine.

13. Method as claimed in claim 4, further comprising retrieving a pulse width interval sequence from a characteristics map as a function of a working point of an electric machine.

14. Method as claimed in claim 5, further comprising retrieving a pulse width interval sequence from a characteristics map as a function of a working point of an electric machine.

15. Device comprising at least one converter or inverter for generating a three-phase current or an alternating current from a direct current by using means for implementing the method as claimed in claim 1.

16. Device as claimed in claim 8, including a clock generator.

17. A method for generating a pulse-width-modulated three-phase voltage or alternating current, comprising the steps of:
providing a direct voltage;
sampling said direct voltage wherein said sampling occurs at a plurality of pulse width intervals.

18. A method according to claim 17, comprising the further steps of:
comparing a plurality of pulse duration with a corresponding plurality of said variable pulse width intervals;
generating said three-phase voltage or alternating current as a function of said steps of comparing.

19. The method according to claim 17, wherein said pulse width intervals are programmable.
